(19) United States
(12) Patent Application Publication
(10) Pub. No.: US 2002/0069280 A1
(43) Pub. Date: Jun. 6, 2002

(54) Method and system for scalable, high performance hierarchical storage management

(75) Inventors: Christian Bolik, Mainz (DE); Peter Gemsjaeger, Stromberg (DE); Klaus Schroiff, Stolberg (DE)

Correspondence Address: Brian C. Kunzler, 10 West 100 South, Salt Lake City, UT, 84101, US

(73) Assignee: INTERNATIONAL BUSINESS MACHINES CORPORATION, Armonk, NY

(21) Appl. No.: 10/015,825

(22) Filed: Dec. 10, 2001

(30) Foreign Application Priority Data
Dec. 15, 2000 (EP) 00127584.1

(51) Int. Cl. G06F 15/173

(52) U.S. Cl. 709/225

(57) ABSTRACT

Disclosed is a mechanism of managing an hierarchical storage management (HSM) system including an HSM server and a file server having a managed file system where the HSM server and the file server are interconnected via a network. Migration of data files from the file server to the HSM server is accomplished by providing at least one list for identifying candidate files to be migrated, scanning the managed file system until having detected a prespecified number of migration candidate files, recording the detected migration candidate files in the provided at least one list of candidate files, monitoring a current state of the managed file system, and migrating at least part of the candidate files identified in the at least one list of candidate files from the file server to the HSM server, dependent on the monitored current state of the managed file system. In parallel, the migrated data files can be identified by a unique identifier that allows direct access to the migrated files. The mechanism enables an efficient handling of large amounts of file based information in the HSM environment by way of an automigration process and is highly scalable with respect to the amount of file based information.

### BACKGROUND OF THE INVENTION

1. The Field of the Invention

The invention generally relates to hierarchical storage management systems and more specifically to a method and system for managing an hierarchical storage management (HSM) environment including at least one HSM server and at least one file server having stored a managed file system, wherein the at least one HSM server and the at least one file server are interconnected via a network and wherein digital data files are migrated temporarily from the at least one file server to the at least one HSM server.

2. The Relevant Art

Hierarchical Storage Management (HSM) is used for freeing up more expensive storage devices, typically magnetic disks, that are limited in size by migrating data files meeting certain criteria, such as the age of the file or the file size, to lower-cost storage media, such as tape, thus providing a virtually infinite storage space. To provide transparent access to all data files, regardless of their physical location, a small “stub” file replaces the migrated file in the managed file system. To the user this stub file is indistinguishable from the original, fully resident file, but to the HSM system the stub file provides important information such as where the actual data is located on the server.

An important difference between the views of a migrated file from the user's and the HSM system's perspective is that the user doesn't see the new “physical” size of the file, which after a file has been migrated is actually the size of the stub file, but still sees the “logical” size, which is the same as the size of the file before it was migrated.

One implementation category of an HSM system makes use of a client/server setup, where the client runs on the machine on which file systems are to be managed, and where the server provides management of migrated data files and the included information.

Traditionally, an HSM system needs to perform the following tasks:

a) Determine which data files in the file system are eligible for migration (referenced as “candidates”). In order to determine the “best” candidates (with respect to their age and size), a full file system traversal is required;

b) Determine which previously migrated files have been modified in or removed from the client file system so their migrated copies can be removed from the server storage pool to reuse the space they occupied (referenced as “reconciliation”). To accomplish this, usually a full file system tree traversal is necessary.

In case of insufficient available space in the client file system, data files need to be migrated off the disk quickly to minimize application latency, herein referenced as “automigration”. If a managed file system runs out of space, all applications performing write requests into this file system are blocked until enough space has been made available by migrating files off the disk to satisfy their write requests. In traditional HSM systems, data files in a managed file system are migrated serially, one file at a time.

An according data migration facility is disclosed in IBM Technical Disclosure Bulletin, published June 1973, pp. 205-208. A supervisorial controller is described for automatic administration and control of a computer system's secondary storage resources. A migration monitor is run-time event driven and acts as a first level event processor. The migration monitor records events and summarizes a data migration activity. A migration task is initiated by the migration monitor when a request is received. The migration task scans through an inventory of authorized data on the system and invokes a given algorithm to make the decision as to what data to migrate.

With the amount of data and the number of data files in a typical managed file system increasing logarithmically over time as illustrated in FIG. 1, scalability of the HSM system becomes an issue. Typical file system environments with such a behavior are those of Internet providers handling the files of much more than thousands of customers, video processing scenarios like those provided on a video-on-demand server, or weather forecast picture processing where millions of high-resolution pictures are generated on a per day basis by weather satellites. In those environments the number of files to be handled often exceeds 1 million and is continuously increasing.

For the above reasons, there exists a strong need to provide HSM systems which are able to handle those very large file systems.

Most of the known HSM approaches traverse the complete file system in order to gather eligible candidates for the automigration to remote storage. This system worked well in rather small environments but are no longer usable for current file system layouts due to the excessive processing time for millions of files. Therefore it is required to provide a more scalable mechanism consuming less system resources.

A known HSM approach addressing an above migration scenario and disclosed in U.S. Pat. No. 5,832,522 proposes a placeholder entry (stub file) used to retrieve the status of a migrated data file. In particular, a pointer is provided by which a requesting processor can efficiently localize and retrieve a requested data file. Further, the placeholder entry allows to indicate migration of a data file to a HSM server.

Another approach, a network file migration system is disclosed in U.S. Pat. No. 5,367,698. The disclosed system comprises a number of client devices interconnected by a network. A local data file storage element is provided for locally storing and providing access to digital data files stored in one or more of the client file systems. A migration file server includes a migration storage element that stores data portions of files from the client devices, a storage level detection element that detects a storage utilization level in the storage element, and a level-responsive transfer element that selectively transfers data portions of files from the client device to the storage element.

Known HSM applications traverse the complete file system tree in order to gather eligible candidates for the automigration to a remote storage. This system worked well in rather small environments but are no longer usable for current file system layouts due to the excessive processing time for millions of files. A complete tree traversal disadvantageously impedes scalability both in terms of duration and resource requirements, as both numbers grow logarithmically with the number of files in a file system. Furthermore, serial automigration is often not capable of freeing up space quickly enough to satisfy today's requirements. Therefore it is required to provide a more scalable mechanism consuming less system resources.

Due to the ever increasing size of storage volume as well as the pure number of storage objects makes it more and more difficult for a data management application to provide its service without an increasing need for more system resources which is obviously not desirable.

### OBJECT AND BRIEF SUMMARY OF THE INVENTION

The hierarchical storage management system of the present invention has been developed in response to the present state of the art, and in particular, in response to the problems and needs in the art that have not yet been fully solved by currently available hierarchical storage management systems. Accordingly, it is an overall object of the present invention to provide a hierarchical storage management system that overcomes many or all of the above-discussed shortcomings in the art.

The underlying concept of the invention is, instead of attempting to find the “best” migration candidates all at once, to scan the file system only until a certain amount of migration candidates have been found. Further, the idea is that the process for determining candidates waits until one of two events to happen, namely until a specified wait interval expires or until an automigration process starts. The candidate determination process advantageously can resume the file system scan at the point where it stopped a previous scan and continue to look for migration candidates, again until a certain amount of candidates has been found.

The particular step of scanning the managed file system only until having detected a prespecified amount of migration candidate files advantageously enables that migration candidates are made available sooner to the migration process wherein migration can be performed as an automigration process not requiring any operator or user interaction. As the at least one attribute the file size and/or a time stamp of the file can be used.

In one embodiment, the automigration process is performed by a master/slave concept where the master controls the automigration process and selects at least one slave to migrate candidate data files provided by the master.

Another embodiment comprises the additional steps of ranking and sorting the candidate data files contained in the at least one list for identifying candidate data files, in particular with respect to the file size and/or time stamp of the data files contained in the at least one list for identifying candidate data files. Hereby the order of candidate data files to be migrated can be determined.

In particular, the proposed mechanism therefore makes the candidates determination process practically independent from the number of files in the file system and from the size of the file system. The invention therefore allows parallel processing of determination of candidate data files for the migration and the automigration process itself.

In addition, the automigration process generates a unique identifier to be stored on the HSM server that allows a direct access to migrated data files during a later reconciliation process.

The proposed scanning process therefore significantly reduces resource requirements since e.g. the storage resources for the candidate file list and the required processing resources for managing the candidate file list are significantly reduced. In addition, the scanning time is also reduced significantly.

The basic principal behind this invention is dropping the requirement of 100% accuracy for the determination of eligible migration candidates. Rather than looking for an analysis based on a complete list of migration candidates we can assume that the service is also functional based on a certain subset of files within a managed file system.

Thereupon, the invention allows for handshaking between the process for determining or searching migration candidates and the process of automigration.

As a result, the invention provides scalability and significant performance improvement of such an HSM system. Thereupon secure synchronization or reconciliation of the client and server storage without need of traversing a complete client file system is enabled due to the unique identifier.

According to an embodiment, at least two lists for identifying candidate data files are provided, whereby the first list is generated and/or updated by the scanning process and whereby the second list is used by the automigration process. The automigration process gathers the first list from the scanning process when all candidate data files of the second list are migrated. Both lists are worked on in parallel thus revealing parallelism between scanning and automigrating.

It is further noted, that besides the above described ‘migrated’ state, also a ‘premigrated’ state for data files in the managed file system can be used for which the migrated copy stored on the HSM server is identical to the resident copy of the data file in the managed file system.

These and other objects, features, and advantages of the present invention will become more fully apparent from the following description and appended claims, or may be learned by the practice of the invention as set forth hereinafter.

### BRIEF DESCRIPTION OF THE DRAWINGS

In order that the manner in which the advantages and objects of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram showing atypical hierarchical storage management (HSM) environment where the present invention can be applied to;

FIG. 2 illustrates the known logarithmic increase of the amount of data and the number of data files in a typical managed file system;

FIG. 3 is flow diagram for illustrating the basic mechanism of managing an HSM system according to the invention;

FIG. 4 is another flow diagram for illustrating the basic mechanism of reconciling a managed file system migrated from a file server to an HSM system;

FIG. 5 is another flow diagram showing a base logic of an automigration environment in accordance with the invention; and

FIGS. 6a, b illustrate a preferred embodiment of the mechanism according to the invention.

### DETAILED DESCRIPTION OF THE PREFERRED EMBODIMENTS

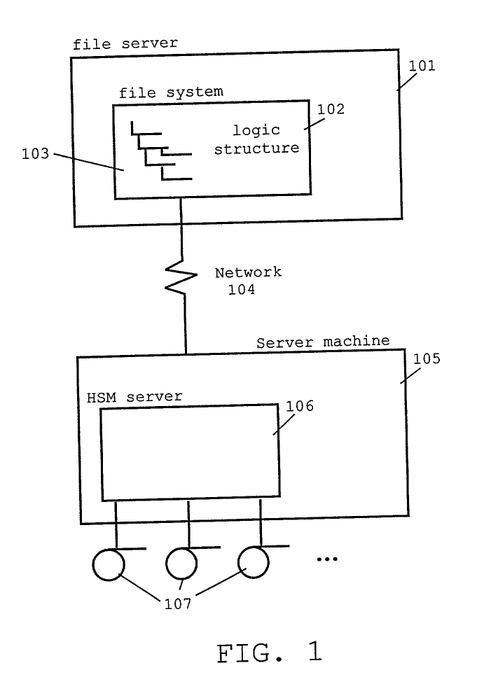

FIG. 1 shows a typical file server 101 that manages one or more file systems 102. Each file system is usually organized in more or less complicated and more or less deeply nested file trees 103. The file server 101 is connected via a network 104, usually a Local Area Network (LAN) or a Wide Area Network (WAN), to another server machine 105 that contains an HSM server 106. The server machine 105 has one or more external storage devices 107, in this example tape storages, attached to. The HSM server 106 stores data, migrated from the file server 101 to the tape storages 107.

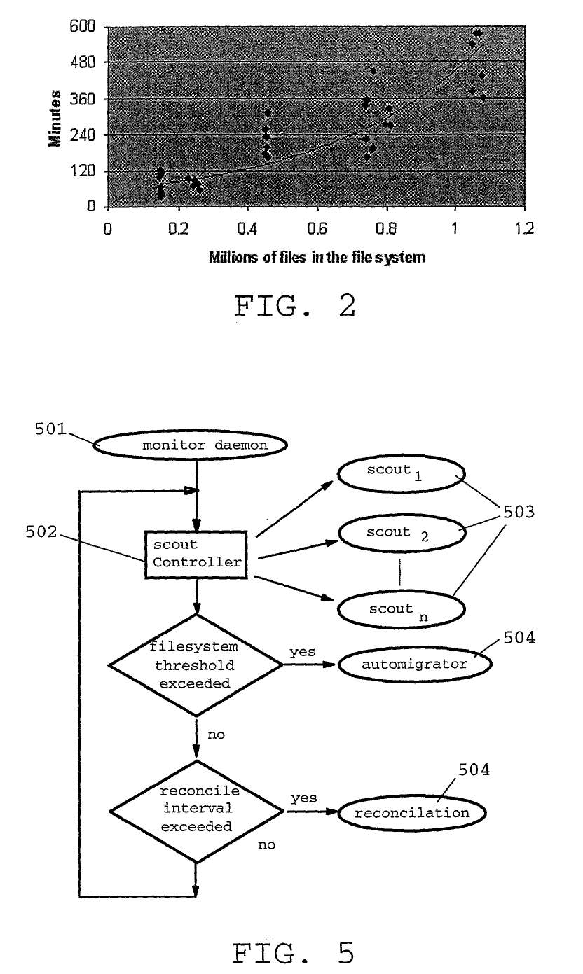

FIG. 2 illustrates that the amount of data and the number of data files in a typical managed file system is increasing logarithmically and is discussed beforehand.

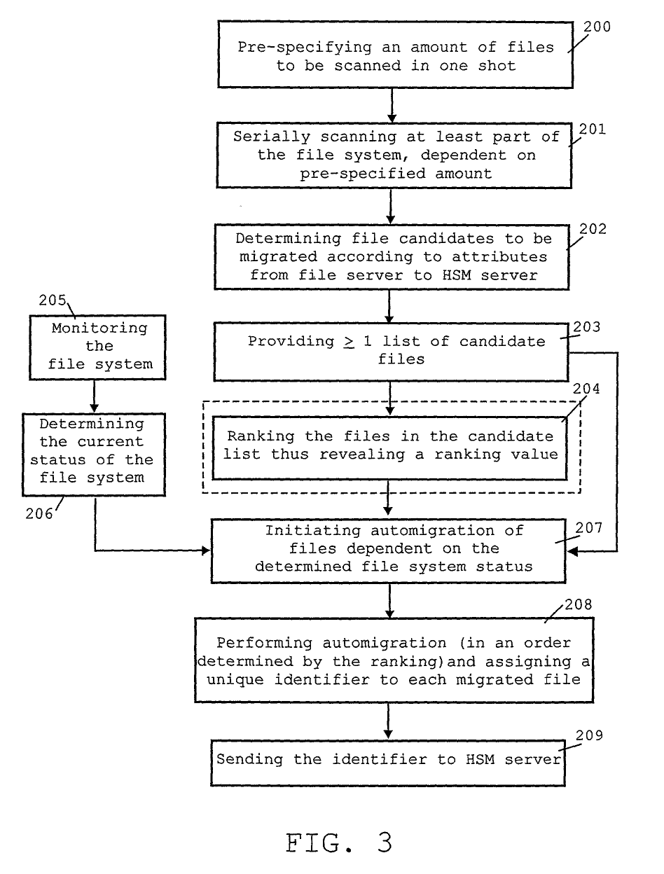

The flow diagram depicted in FIG. 3 illustrates the basic mechanism of managing an HSM system according to the invention. In step 200, an amount of files, e.g. the number of files or the entire size of multiple files, for which a scan in the file system shall be performed, is pre-specified. Based on that pre-specified amount, at least part of the file system is scanned 201. It is an important aspect of the invention that not a whole file system is scanned through but only a part of it determined by the pre-specified amount.

In a next step 202, based on one or more attributes like the file size or a time stamp for the file (file age or the like), candidate files to be migrated from the file server to the HSM server are determined. The determined candidate files are put into a list of candidates 203. It is noteworthy hereby that, in another embodiment of the invention, two lists are provided. Such an embodiment is described hereinbelow in more detail.

Step 204 is an optional step (indicated by the dotted line) where the data files contained in the candidate list are additionally ranked in order to enable that the following selected files to be migrated can be migrated in a particular order.

In parallel to the steps 200-204 described above, the file system is monitored 205 and the current status of the file system is determined 206. In step 207, an automigration of selected and allegedly ranked candidate data files is initiated or triggered by the determined file system status. For the details of that file system status it is referred to the following description.

After the automigration has been initiated, it is performed 208 by physically transferring data files to the HSM server and, in particular, a unique identifier is assigned to each migrated file. The concept and meaning of that unique identifier (ID) will become more evident from the following parts of the description. Finally the unique identifier is sent to the HSM server.

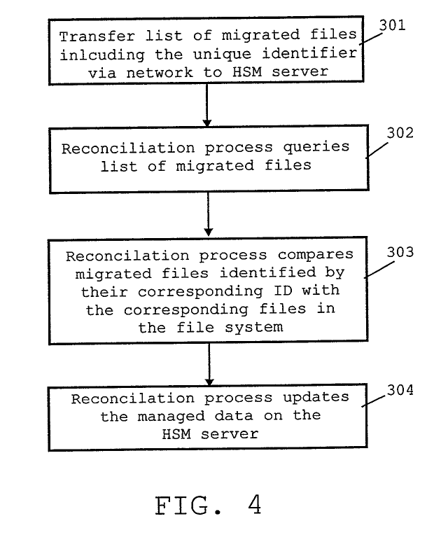

Now referring to the flow diagram depicted in FIG. 4, the basic mechanism of reconciling a managed file system migrated from a file server to an HSM system, in accordance with the invention, shall be illustrated. In a first step 301, a list of already migrated data files is transferred via the network from the HSM server. The transferred list, in particular, includes the unique identifier generated in the process described referring to FIG. 3. Then a reconciliation process queries 302 the transferred list of migrated files and compares 303 the migrated files, which are identified by their corresponding unique identifier (ID) with the corresponding files contained in the managed file system. Finally, the reconciliation process accordingly updates 304 the managed data on the HSM server.

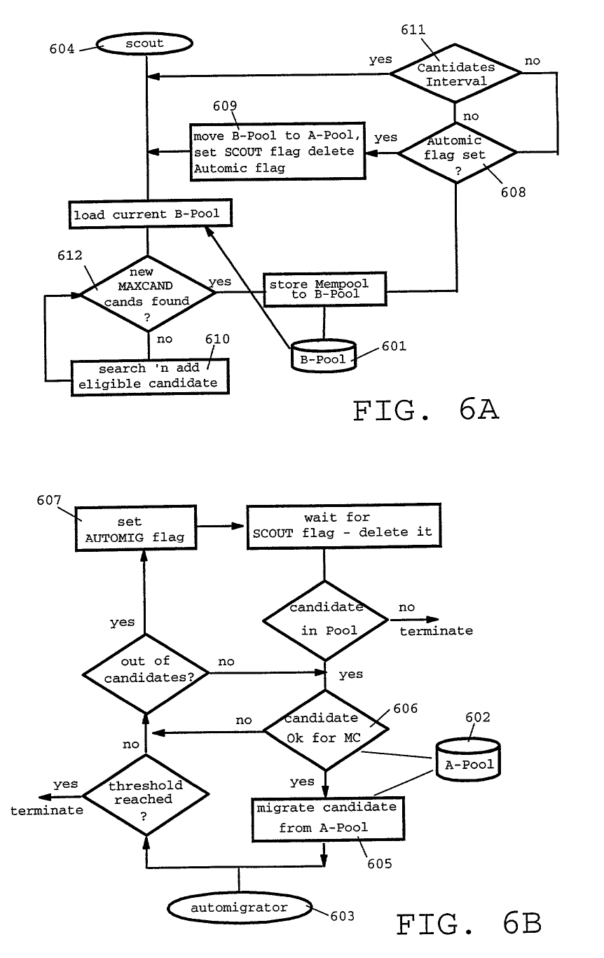

The flow diagram depicted in FIG. 5 shows a base logic of an automated HSM environment. A monitor daemon 501 starts a master scout process 502 and continuously monitors one or more file system. The master scout process 502 starts one slave scout process 503 per file system. Each slave scout process 503 scans its file system for candidate data files to be migrated.

If the monitor daemon 501 detects that the file system has exceeded its threshold limits, it starts a master automigration process 504, described in more detail hereinbelow. If the value for a reconcile interval has exceeded, a reconciliation process 505 is started by the monitor daemon 501. The reconciliation process 505 is also described in more detail in the following.

The flow diagrams depicted in FIG. 6a and 6b illustrate a preferred implementation based on independent migration candidates pools 601, 602 for the automigration 603 and scanning process 604, the latter often (and in the following) referred to as “scout” process.

In this embodiment, the automigrator 603 is activated by another process—e.g. a monitor process that tracks file system events and takes appropriate measurements if certain thresholds are exceeded. The automigration 603 then starts to migrate 605 migration candidates to a remote storage as long as some defined threshold is exceeded. Prior to migrating 605 the files, the automigration process 603 performs management class (MC) checks 606 with the HSM server to find out whether a potential migration does not violate HSM server side rules.

If the automigration process 603 runs out of candidates, i.e. the list of identified candidates 602 is used up, it sets 607 a flag to signal a request to the scout process 604 in order to obtain a new list 601 of candidates. The scout process 604 receives 608 the flag and moves 609 the newly generated list 601 to the automigrator 603, setting 609 another flag to signal the automigrator 603 to continue with migrating files.

The scout process 604 itself starts to collect 610 new migration candidates. After completion of the scanning, the scout process 604 will wait until it receives another signal by the automigrator or by exceeding a definable value CANDIDATESINTERVAL 611. The value CANDIDATESINTERVAL 611 defines the time period during the scout process 604 remains sleeping in the background after an activity phase.

In the latter case of exceeding the CANDIDATESINTERVAL 611, it starts optimizing its candidates list with another scan. I.e. in case of not receiving a signal from the automigration process, in order to improve the quality of the candidates list scout process starts at each CANDIDATESINTERVAL 611 to scan for a new bunch of candidates. That bunch of candidates is defined by another value MAXCANDIDATES 612 that defines a number of required candidates following candidates criteria. Combined with the existing migration candidates list 601 the scout process 604 can either collect all candidates or just take the “best” subset in order to limit the required storage space. Thus the scout process traverses the managed file system in order to find eligible candidates for automigration. Rather than traversing the complete file system it stops as soon as MAXCANDIDATES 612 eligible candidates were found. Hereafter the process either waits for a dedicated event from the automigration process or sleeps till CANDIDATESINTERVAL 611 time has passed.

The above scout process has the following advantages:

Minimal consumption of system resources (memory, processing time) required to find eligible candidates;

highly scalable with minimal dependencies regarding the number of objects within a file system;

increasing candidates quality in times of normal file system activity.

As a possible disadvantage, it is possible that the potentially best migration candidates based on the selection strategy are not used by the automigration process because the scout process has not yet traversed the corresponding subtree. Nevertheless, the above advantages considerably exceed the disadvantages.

In the following, the different process steps of the whole migration mechanism proposed by the invention is described in more detail.

Candidates Determination

Avoiding Full File System Traversals

Instead of attempting to find the “best” migration candidates in one shot, the file system is scanned only until a certain number of migration candidates have been found. Then, the candidates determination process waits for one of two events to happen:

a specified wait interval expires, or

automigration starts.

In this event, the process resumes the file system scan at the point where it left off and continues to look for migration candidates, again until a certain number of candidates has been found. These candidates are merged into the existing list of candidates and then “ranked” for quality (with respect to age and size), thus incrementally improving the quality of migration candidates in the system.

The benefit of this approach is that migration candidates are made available sooner to the automigration process, and significantly reduced resource requirements, making the candidates determination process practically independent from the number of files in the file system and from the size of the file system.

Quick Eligibility Check

A file can be eligible for migration only if it is not yet migrated. On file systems that don't provide an XDSM API (X/Open Data Storage Management API), such as AIXJFS, the migration state typically needs to be determined by reading a stub file. In order to limit the number of files that the candidates determination process needs to read, usually only those files are read whose physical size meets the criteria for being a stub file, but even then the performance impact on file systems with a high percentage of migrated files is significant as the read/write head of the hard disk constantly needs to jump back and forth between the inode area of the file system and the actual data blocks. To address this, the present invention proposes to require all stub files to have a certain characteristic, such as a specific physical file size. The candidates determination process, then, can assume that all files whose physical size matches the stub file size are migrated and disregard them from further eligibility checking that would require reading the stub file. This will exclude resident files whose size make them appear like stub files from migration, but the assumption is that the percentage of such files in a typical file system is small enough to make this a viable simplification.

In addition, the automigration process signals the need for additional migration candidates. Once the file system exceeds a certain fill rate or runs out-of storage capacity the automigration process gets started—usually initiated by the supervising daemon running permanently in the background. Hereby it consumes migration candidates from a dedicated automigration pool and signals the scout process to dump his set of migration candidates to disk or to transfer it into a migration queue via shared memory. Based on the newly dumped candidates list the automigration process can now start to migrate data to the remote HSM server—preferably multithreaded and via multiple processes where each migrator instance cares about a certain set of files.

In order to guarantee maximum concurrency, the scout process can immediately start to scan for new migration candidates after transferring his current list to the automigration process. The immediate generation of a new candidates list insures that the automigration process does not run out-of migration candidates or minimizes the wait time. Under normal conditions new candidates are found much faster than the network transfer of the already found candidates so we can assume that this is no bottleneck in this environment.

Automigration

Parallel Automigration

To lift the scalability limitations of the traditional serial automigration, the present invention proposes a master/slave concept to facilitate parallel automigration of files in the same file system. In this concept, a master automigration process reads from a list of migration candidates created by the candidates determination process and dispatches entries from this file to a certain number of automigration slaves (“migrators”). These slaves migrate the file they are assigned to the HSM server, and then are available again for migrations as assigned by the master process.

The essential benefit is the scalability of the speed by which files can be migrated off the file system, by defining the number of parallel working automigration slaves. The complete control of the automigration process remains sequential (master automigration process), so that no additional synchronization effort is required, as it would be like in other typical parallel working systems. The “real work”, the migration of the files itself, that consumes most of the time during the whole automigration process, is parallelized.

Reconciliation

Immediate Synchronization

To reconcile a client/server HSM system, the HSM client, according to the prior art, has to perform the following steps:

Retrieve the list of migrated files for a given file system from the HSM server (the “server list”) and

Traverse the file system tree, marking each unmodified migrated file as “found” in the server list.

When tree traversal is completed, all files in the server list not marked “found” will be marked for removal from a server storage pool, as they were either removed from the client file system, or their client copy was modified, thus invalidating the server copy. The reconciliation processing known in the prior art therefore requires a fall file system tree traversal, which poses the scalability problems described above. To avoid the need for a full traversal, the invention proposes the following processing:

When migrating files, the HSM client stores a unique, file system-specific identifier (the “file ID”) with the file on the HSM server;

during reconciliation, the HSM client retrieves the list of migrated files, in particular by use of the unique ID stored in the list or array, from the server as before, but now the server list includes the file id for each entry;

for each entry from the server list received, the HSM client invokes a platform-specific function that returns the file attributes of a file identified by its file id. On IBM AIX (UNIX derivate) this makes use of the vfs_vget VFS entry point, which should be invoked so that it reads the attributes directly from the underlying physical file system to avoid having to read the stub file, whereas on DMAPI-enabled file systems the dm_get_fileattr API is used;

if the attributes could be determined and match with those stored in the server list, processing continues with step 3 until all entries have been received. Otherwise the entry will be added to a list in client memory that will be used to mark files for removal on the server (the “remove list”);

when all entries from the server list have been received and processed, the HSM client loops through the remove list, and marks each of them for removal from the server storage pool.

Quick Premigration Check

In addition to the “migrated” and “resident” states of a file, some HSM systems provide a third state: “premigrated”. A file is “premigrated” when its copy on the server (after migration) is identical to the (resident) copy of the file in the client file system. This is the case for instance immediately after a migrated file is copied back to the local disk: the file is resident, but its migrated copy is still present in the server storage pool, and both copies are identical.

The benefit of the premigration state is that such files can be migrated simply by replacing them with a stub file, without having to migrate the actual data to the HSM server. On file systems that don't provide the XDSM API the HSM client needs to keep track of the premigrated files in a look-aside database (referenced as “premigration database”), as premigrated files don't have an associated stub file that could be used to store premigration information.

Those HSM clients, that rely on a look-aside database, need to traverse the local file system to verify the contents of the premigration database. However, making use of the same principle proposed in the previous section “Immediate Synchronization”, the need for a full tree traversal can be removed here as well by storing a unique file id for each premigrated file in the premigration database, and then perform a direct mapping from its entries into the file system. Entries whose mapping is no longer successful can be removed from the premigration database.

Finally it is emphasized that combined with one another, the proposed measures resolve the most pressing scalability problems and performance bottlenecks present in traditional client/server-based HSM systems.

What is claimed and desired to be secured by United States Letters Patent is:

1. A method of managing a hierarchical storage management (HSM) environment, the environment including at least one HSM server and at least one file server having stored a managed file system, wherein the at least one HSM server and the at least one file server are interconnected via a network and wherein digital data files are migrated temporarily from the at least one file server to the at least one HSM server, the method comprising:
providing at least one list for identifying candidate data files to be migrated;
prespecifying a scanning scope;
scanning the managed file system until the scanning scope is reached;
selecting migration candidate data files according to at least one attribute;
recording the selected migration candidate data files in the provided at least one list for identifying candidate data files; and
migrating at least part of the selected candidate data files identified in the at least one list for identifying candidate data files from the file server to the HSM server.

2. The method according to claim 1, wherein the scanning scope is determined by the number of candidate data files and wherein the managed file system is scanned until having reached the prespecified number of migration candidate data files.

3. The method according to claim 1, wherein the scanning scope is determined by the total amount of data for the candidate data files and wherein the managed file system is scanned until having the prespecified amount of data.

4. The method according to claim 1, wherein the scanning of the managed file system is resumed at a location of the managed file system where a previous scanning is left off, and continued accordingly.

5. The method according to claim 1, wherein replacing a migrated data file in the managed file system by a stub file providing at least information about the location of the migrated data file on the HSM server.

6. The method according to claim 1, further comprising monitoring a current state of the managed file system and initiating automigration dependent on the monitored current state of the managed file system.

7. The method according to claim 6, comprising the further steps of automigrating candidate data files with respect to the list for identifying candidate data files and assigning a unique identifier to each of the migrated candidate data files.

8. The method according to claim 7, wherein the unique identifier is specific to the underlying file system allowing direct access to a migrated data file.

9. The method according to any of claim 6, wherein providing two lists for identifying candidate data files, whereby the first list is generated and/or updated by a scanning process and whereby the second list is used by a automigration process, and whereby the automigration process gathers the first list from the scanning process when all candidate data files of the second list are migrated.

10. The method according to any of claim 9, wherein the automigration process is performed by a master/slave concept where the master controls the automigration process and selects at least one slave to migrate candidate data files provided by the master.

11. The method according to claim 1, comprising the additional steps of ranking and sorting the candidate data files contained in the at least one list for identifying candidate data files, in particular with respect to the a file size and/or time stamp of the data files contained in the at least one list for identifying candidate data files.

12. The method according to claim 1, wherein the scanning of the managed file system is initiated dependent on expiration of a prespecified wait interval or initiated by the automigration process.

13. A method of reconciling a managed file system migrated from a file server to an hierarchical storage management (HSM) server via a network in accordance with the method according to any of claims 7 to 12, with a current state of the managed file system on the file server, wherein data files migrated to the HSM server are recorded in a list of migrated data files having a unique identifier for each of the migrated data files, the method comprising the steps of:
querying the list of migrated data files migrated from the managed file server to the HSM server;
for each file entry in the list of migrated data files, retrieving from the managed file system at least one attribute of the migrated data file that is identified by the corresponding unique identifier;
comparing the retrieved attributes with the corresponding attributes stored in the list of migrated data files; and
updating the HSM server for the migrated managed file system dependent on the results of the preceding step of comparing.

14. The method according to claim 13, wherein performing the steps of claim 13 by a reconciling process and wherein the reconciling process requests the list of migrated data files via the network from the HSM server.

15. A hierarchical storage management (HSM) system including at least one HSM server and at least one file server having stored a managed file system, the at least one HSM server and the at least one file server being interconnected via a network, where data files are migrated temporarily from the at least one file server to the at least one HSM, the system comprising:
a first means for scanning the file system and for identifying candidate data files to be migrated;
a second means for monitoring the managed file system;
a third means for migrating candidate data files to the HSM server;
a fourth means for reconciling the managed file system.

16. The system according to claim 15, further comprising a means for replacing a migrated data file in the managed file system by a stub file providing at least information about the location of the migrated data file on the HSM server.

17. The system according to claim 15, further comprising means for assigning a unique identifier to at least part of the candidate data files stored in the storage means.

18. The system according to claim 15, further comprising at least two storage means for identifying candidate data files, where the first storage means is generated and/or updated by a scanning process and where the at least second storage means is used by an automigration process, and where the automigration process gathers the content of the first storage means from the scanning process when all candidate data files of the at least second storage means are migrated.

19. A data processing program for execution in a data processing system comprising software code portions for performing a method comprising:
providing at least one list for identifying candidate data files to be migrated;
prespecifying a scanning scope;
scanning the managed file system until the scanning scope is reached;
selecting migration candidate data files according to at least one attribute;
recording the selected migration candidate data files in the provided at least one list for identifying candidate data files; and
migrating at least part of the selected candidate data files identified in the at least one list for identifying candidate data files from the file server to the HSM server.

20. An article of manufacture comprising a program storage medium readable by a processor and embodying one or more instructions executable by the processor to perform a method comprising:
providing at least one list for identifying candidate data files to be migrated;
prespecifying a scanning scope;
scanning the managed file system until the scanning scope is reached;
selecting migration candidate data files according to at least one attribute;
recording the selected migration candidate data files in the provided at least one list for identifying candidate data files; and
migrating at least part of the selected candidate data files identified in the at least one list for identifying candidate data files from the file server to the HSM server.
